(19) United States
(12) Patent Application Publication
(10) Pub. No.: US 2023/0262371 A1
(43) Pub. Date: Aug. 17, 2023

(54) AUDIO APPARATUSES

(71) Applicant: SPA-TECH INTERNATIONAL LIMITED, Hong Kong (CN)

(72) Inventor: Hung Cheong Tang, Hong Kong (CN)

(21) Appl. No.: 18/137,446

(22) Filed: Apr. 21, 2023

Related U.S. Application Data
(63) Continuation of application No. PCT/IB2022/053807, filed on Apr. 25, 2022.

(30) Foreign Application Priority Data
Apr. 23, 2021 (HK) 32021029830.5

(51) Int. Cl. H04R 1/02; H04R 1/44; H04R 1/28

(52) U.S. Cl. CPC H04R 1/028; H04R 1/44; H04R 1/2811; H04R 2400/11; H04R 2499/10

(57) ABSTRACT

An audio apparatus (100) comprising a first container (110) which is an inner container, a second container (120) which is an outer container surrounding the first container, and a bridging portion (130) interconnecting the top ends of the first container (110) and the second container (120); the first container (110), the second container (120) and the bridging portion (130) cooperating to define an inter-container space inside which an audio arrangement is situated and operable to generate audible signals for transmitting out of the apparatus.

### CROSS REFERENCE TO RELATED APPLICATIONS

The present application is a Continuation Application of PCT Application No. PCT/IB2022/053807 filed on Apr. 25, 2022, which claims the benefit of Hong Kong Patent Application No. 32021029830.5 filed on Apr. 23, 2021. All the above are hereby incorporated by reference in their entirety.

### FIELD

The present disclosure relates to audio apparatus, and more particularly to audio apparatus for use in bathrooms.

### BACKGROUND

Audible signals can be a source of enjoyment or relaxation for many people. It would be beneficial if audible signals can be made available to people while soaked in a liquid of enjoyments such as when a person is enjoying a bath. At a minimum, it would be advantageous if audible signals can be propagated through a container such as a bathtub.

### SUMMARY OF DISCLOSURE

An audio apparatus comprising a main body and an audio arrangement. The main body includes a first container which is an inner container, a second container which is an outer container, and a bridging portion interconnecting the inner container and the outer container. The first container, the second container and the bridging portion cooperate to define an inter-container space. The audio arrangement is configured to generate audible signals to travel along the inter-container space, to surround the first container, and/or to propagate through the first container and/or the second container.

The audio arrangement comprises a set of audio transducers including at least one audio transducer. The audio transducer is configured to receive electroacoustic signals from a signal source by wireless and/or wired signal transmission means.

The first container comprises a first peripheral wall and a base portion having a base surface, the first peripheral wall surrounding and cooperating with the base surface to define a liquid-receiving volume of the first container, and wherein the liquid receiving volume has a depth which is measured along an axial direction. The second container comprises a second peripheral wall which surrounds the first peripheral wall, the second peripheral wall cooperating with the first peripheral wall to define a peripheral airgap which is an interwall airspace surrounding the first peripheral wall. The first peripheral wall and the second peripheral wall are interconnected by a peripherally extending bridging portion, and wherein the bridging portion defines a top end of the peripheral airgap. The set of audio transducers is received inside the peripheral airgap and is configured for generating audio vibrations inside the interwall airspace for transmitting out of the first container through the first peripheral wall and out of the second container through the second peripheral wall.

A cartridge assembly comprising a cartridge housing and a cartridge receptacle is disclosed. The cartridge assembly comprises a retention system including an engagement system and a locking system. The engagement system comprises an engagement means on the cartridge housing and a counterpart engagement means on the cartridge receptacle. The locking system comprises locking means on the cartridge housing and a counterpart locking means on the cartridge receptacle. The engagement system is configured to facilitate engagement such as snap engagement between the cartridge housing and the cartridge receptacle in at least a first dimension which is an engagement dimension. The locking system is configured to facilitate locking between the cartridge housing and the cartridge receptacle in at least a second dimension which is a locking dimension that is orthogonal to the first dimension. The locking between the cartridge housing and the cartridge receptacle is releasable, and may be releasable by a releasing action by applying a releasing force in a direction orthogonal to the engagement dimension and the locking dimension.

### FIGURES

The present disclosure will be described by way of example with reference to the accompany figures, in which:

FIG. 1A is a schematic perspective view showing an audio apparatus of the present disclosure,

FIG. 1B is a cross-sectional view of the audio apparatus of FIG. 1A taken along an axis Y-Y′ and in a direction towards a fourth peripheral wall portion 112D,

FIG. 2A is a perspective view showing an inner container of the audio apparatus of FIG. 1A,

FIG. 2B is a perspective view showing an outer container of the audio apparatus of FIG. 1A,

FIG. 3 is a schematic view showing the audio apparatus of FIG. 1A connected to a wall mounted power supply,

FIG. 4 is a schematic view showing example propagation of audible vibration generated by the audio system of FIGS. 1A and 1B,

FIGS. 5A and 5B are, respectively, front and side elevation views of an example audio cartridge of the present disclosure,

FIG. 5C is an exploded view of the example audio cartridge of FIG. 5A,

FIG. 5C1 is a further exploded view of the audio cartridge of FIG. 5A without the cover,

FIGS. 6A and 6B are, respectively, front and side elevation views of an example cartridge receptacle configured to receive the audio cartridge of FIGS. 5A and 5B,

FIG. 6C is a rear view of the cartridge receptacle of FIG. 6A,

FIG. 6D is an exploded view of the example cartridge receptacle of FIG. 6A,

FIG. 7 is a cross-sectional view of an audio cartridge assembly comprising the audio cartridge of FIG. 5A and a cartridge receptacle of FIG. 6A,

FIG. 7A is a cross-sectional view of the audio cartridge assembly attached to a peripheral wall,

FIG. 7B is a cross-sectional view showing the audio cartridge assembly in a detached form,

FIG. 7C is a cross-sectional view showing the audio cartridge assembly and the tool in mechanical interaction, and

FIG. 8 is an elevation view of an example tool.

### DESCRIPTION

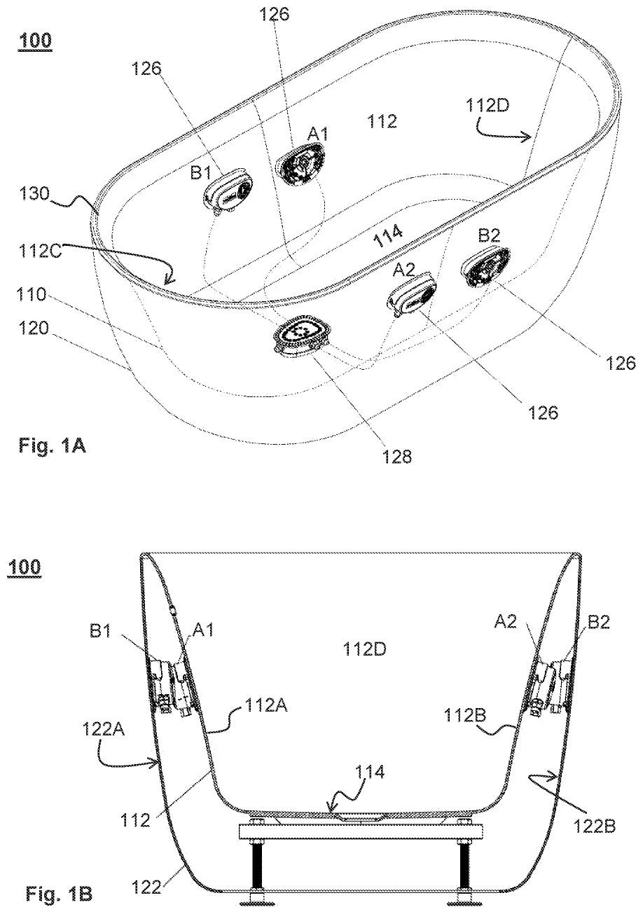

An apparatus of the present disclosure comprises a main body and an audio arrangement. The main body comprises a first container 110, a second container 120, and a bridging portion 130 interconnecting the first container and the second container, as shown in FIGS. 1A and 1B.

The first container 110 is configured for storing liquid and comprises a base portion having a base surface 114 and a peripheral wall 112 which extends between a bottom end and a top end. The peripheral wall 112 of the first container, which is an inner or a first peripheral wall of the apparatus, extends upwardly from the periphery of the base surface 114 and cooperates with the base surface to define a liquid-storing volume of the first container 110. The bottom end of the peripheral wall joins the periphery of the base surface 114 and the top end joins the bridging portion 130 and defines a top aperture.

The liquid-storing volume has a depth which is measured in an upward axial direction with respect to the bottom surface. The upward axial direction is a direction which is defined by an upward axis Z. The first container 110 has a length which is measured in a first direction which is defined by a first axis X-X′ and a width which is measured in a second direction which is defined by a second axis Y-Y′ which is orthogonal to the first axis, the first axis being orthogonal to both the second axis and the upward axis.

The second container 120 comprises a peripheral wall 122 which extends along a peripheral direction to surround the first container and which extends upwardly between a bottom end and a top end. The peripheral wall 122 of the second container is an outer or a second peripheral wall of the apparatus which defines a receptacle for receiving the first container. The bottom end of the second peripheral wall defines a bottom aperture and the top end of the second peripheral wall is in abutment with the bridging portion.

The first peripheral wall 112 and the second peripheral wall 122 are spaced apart and cooperate with the bridging portion to define a peripheral air space which is an inter-container space or an inter-peripheral-wall space. The peripheral air space extends in the peripheral direction to form an air space loop which extends along the peripheral direction and surrounds the first container. The air loop has a plane which is orthogonal to the Z-axis and has a height, measured in the direction of the Z-axis, comparable or equal to the height of the first peripheral wall. The peripheral air space includes a first peripheral space portion which is on a first side of the first axis and a second peripheral space portion which is on a second side of the first axis such that the first axis is intermediate the first peripheral space portion and the second peripheral space portion.

The bridging portion extends along the peripheral direction and projects transversely outwards from the top end of the first peripheral wall to define the ceiling of the peripheral air space. The peripheral air space is an interior space of a sound box defined by the first peripheral wall, the second peripheral wall and the bridging portion.

The transversal separation distance between the first and second peripheral walls, measured in the Y-direction, may be between 2-25 cm.

In example embodiments, the bridging portion interconnects the top ends of the first peripheral wall and the second peripheral wall to close the top end of the peripheral air space.

The audio arrangement comprises an audio transducer arrangement which is configured for connection to an audio signal source to generate human audible audio signals, such as songs, music or vocals, and is located inside the inter-container space. The audible audio signals are configured to be generated inside the inter-peripheral-wall space and the audio transducer arrangement is mounted inside the inter-peripheral-wall space and configured to transmit audible audio signals inside the inter-container space, for example, in the peripheral direction and/or other directions.

The audio transducer arrangement may comprise one audio transducer or a plurality of audio transducers. An audio transducer may be attached to a peripheral wall of the sound box. The peripheral wall of the sound box is an internal wall of the peripheral air space. The internal wall may comprise the first peripheral wall, the second peripheral wall, and/or the ceiling of the peripheral air space which is defined by the bridging portion.

An audio transducer includes a sound propagation surface which may be in abutment with a peripheral wall. The sound propagation surface may be a forward surface or a back surface of the audio transducer. An audio transducer converts electrical signal into mechanical vibrations of audio frequencies. When an audio transducer attached to the peripheral wall is in operation, the mechanical vibrations caused by the audio transducer will generate audio signals inside the airgap and the vibrations will also be transmitted to the peripheral wall in abutment.

The apparatus may comprise one audio transducer or a plurality of audio transducers. An audio transducer may be placed on the first peripheral wall, the second peripheral wall, or intermediate the first and second peripheral walls. The plurality of audio transducers may comprise an audio transducer on the first peripheral wall, an audio transducer on the second peripheral wall, and/or an audio transducer located between the first and second peripheral walls. The plurality of audio transducers may comprise a first audio transducer on a first side of the first axis and/or a second audio transducer on the second side of the first axis. The plurality of audio transducers may comprise a first audio transducer on a first side of the second axis and/or a second audio transducer on the second side of the second axis.

Therefore, the plurality of audio transducers may comprise one on a first side of the first axis, one on the second side of the first axis, one on a first side of the second axis, one on the second side of the second axis, one on a first end of the first axis, one on the second end of the first axis, one on a first end of the second axis, one on the second end of the second axis, or a combination selected from any of the aforesaid.

The first container which is an inner container may be configured as a bathtub. The bathtub may be formed of acrylic, for example, by molding. An example bathtub has a length of between 1.2 m and 2.5 m measured along the first axis which is a longitudinal center axis, a width of between 0.6 m and 2.5 m measured along the second axis which is a transversal center axis, and a depth of between 0.4 m and 1 m. The first peripheral wall may have a thickness of between 2.5 mm to 8 mm.

Where the inner container is configured as a liquid container such as a bathtub, the inner container may be in a first state which is an empty state in which in the inner container is drained or empty, as shown in FIG. 1B, or in a second state which is a filled state in which the inner container is filled with liquid, as shown in FIG. 4. The bath liquid may be water or an aqueous solution. The audio properties of the inner container will change when the inner container changes from the first state to the second state or vice versa due to the damping effect of the bath liquid inside the first container. The damping effect also changes when the liquid level LL in the inner container changes.

On the other hand, the audio properties of the second container, which is an outer container, will not change (including not noticeably changed or will change less substantially) when the inner container changes from the first state to the second state or vice versa, since the outer container is maintained in a spaced apart configuration with respect to the inner container apart from the bridging interconnection at the top periphery.

The first container, the second container, the bridging portion, and the inter-container airgap cooperate to form a sound box resembling that of an audio speaker and produce unexpectedly complex and rich audio effects when audio signals are generated inside the sound box.

In example installations, the first container is elevated above a support surface SS, for example, by a support structure ST, as shown in FIG. 4. The support structure is a weight-bearing structure which is configured to bear the weight of the first container when the first container is in its filled state. The support structure may comprise an ensemble of struts or stays to keep the weight down and the region between the base portion of the first container and the support surface, which is the bottom region of the apparatus, is substantially hollow.

Where the bottom region is hollow, including substantially hollow, the bottom region and the inter-container air space are in fluid communication and audio signals can traverse through the bottom region to move between different sides of the inter-container air space.

The second container may be mainly supported by the first container. For example, the second container may be supported by the first container by means of the peripherally extending bridging portion which overhangs the first container. The second container may also be supported, for example, partially supported, by the bottom edge of its peripheral wall and the floor.

The first container and the second container may be made of the same polymeric material, for example, acrylic such as vacuum-formed acrylic sheets reinforced with fiberglass and resin. A composite wall made of acrylic with fibreglass and resin reinforcement is light weight, strong, durable and has demonstrated good acoustic qualities.

In example embodiments, the second peripheral wall has a height, measured in the Z-direction, which is larger than the height of the first peripheral wall such that the bottom end of the second peripheral wall is below the bottom end of the first peripheral wall.

The second peripheral wall may be configured such that its bottom end is flush with the bottom end of the support structure or in abutment with or close proximity to the support surface.

An example apparatus 100 as shown in FIGS. 1A and 1B is configured as a bathtub comprising an audio arrangement. The example bathtub includes a main body comprising first container 110 comprising a first peripheral wall 112 and a bottom portion 114, a second container 120 comprising a second peripheral wall 122, and a bridging portion 130 interconnecting the first container 110 and the second container 120. The example audio arrangement comprises a plurality of audio transducers 126 and a signal source 128 for generating audio signals for operation of the audio transducers. The example plurality of audio transducers comprises an example plurality of two audio transducers mounted on the first peripheral wall and an example plurality of two audio transducers mounted on the second peripheral wall. The first peripheral wall comprises a first wall portion 112A which is a first sidewall on a first side of the first axis X-X′ and a second wall portion 112B which is a second sidewall on a second side of the first axis such that the first axis is intermediate the first wall portion and the second wall portion. The first peripheral wall comprises a third wall portion 112C which is a first end-wall on a first side of the second axis Y-Y′ and a fourth wall portion 112D which is a second end-wall on a second side of the second axis such that the second axis is intermediate the third wall portion and the fourth wall portion. A sidewall and an end wall adjacent the sidewall may be connected by a curved transition wall portion so that the corner interconnecting the sidewall and the adjacent sidewall is a rounded corner. In example embodiments, the corners of the inner container are rounded or concaved corners. The inner container may flare on extending upwards so that the clearance defined by the top end of the inner container is larger than the area surrounded by the lower end of the first peripheral wall.

The second peripheral wall 122 comprises a first wall portion 122A which is on a first side of the first axis and a second wall portion 122B which is on a second side of the first axis. The second peripheral wall comprises a third wall portion which is on a first side of the second axis Y-Y′ and a fourth wall portion which is on a second side of the second axis such that the second axis is intermediate the third wall portion and the fourth wall portion. The first peripheral wall and the second peripheral wall cooperate to define an inter-peripheral-wall space which extends to surround the first container and which is surrounded by the second container. The inter-peripheral-wall space comprises a first peripheral space portion which is on a first side of the first axis, a second peripheral space portion which is on a second side of the first axis, a third peripheral space portion which is on a first side of the second axis, and a fourth peripheral space portion which is on a second side of the second axis. The example signal source is located inside the bottom region and is mounted on the underside of the first container in this example.

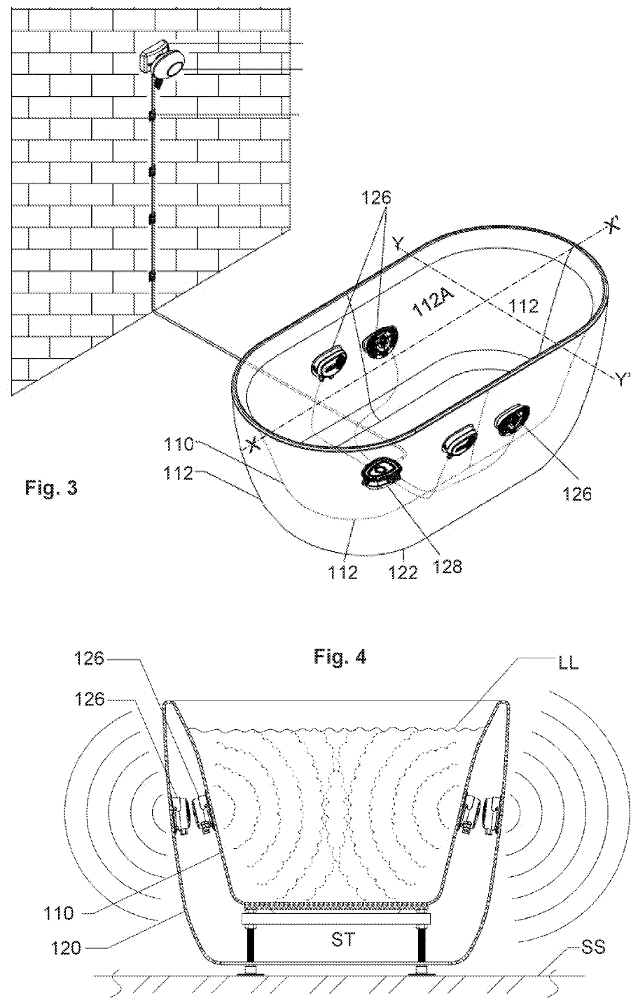

The example apparatus 100 may be connected to a low-voltage (LV) power supply, for example, a wall-mounted LV power supply to obtain its operational power supply, as shown in FIG. 3. The LV power supply may be a toolless plug-in battery module which can be attached or detached to a wall socket without a tool.

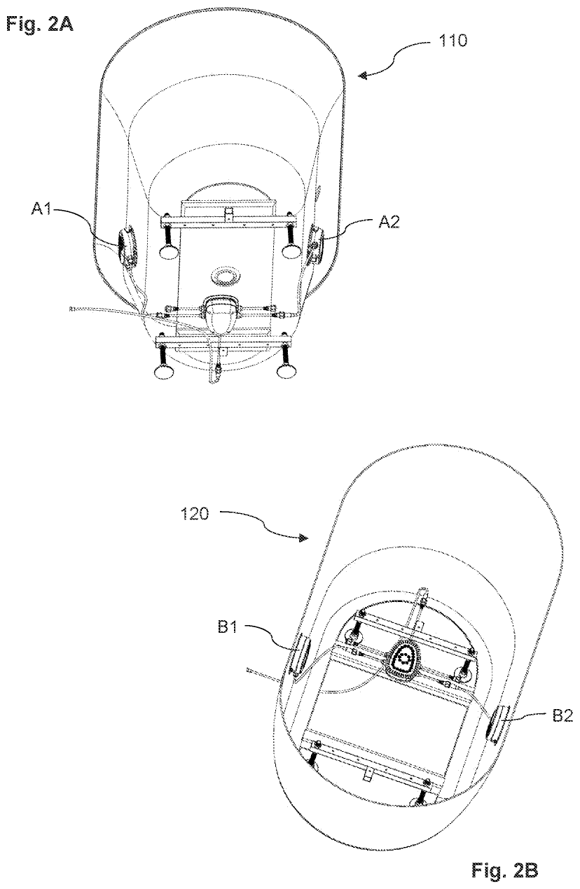

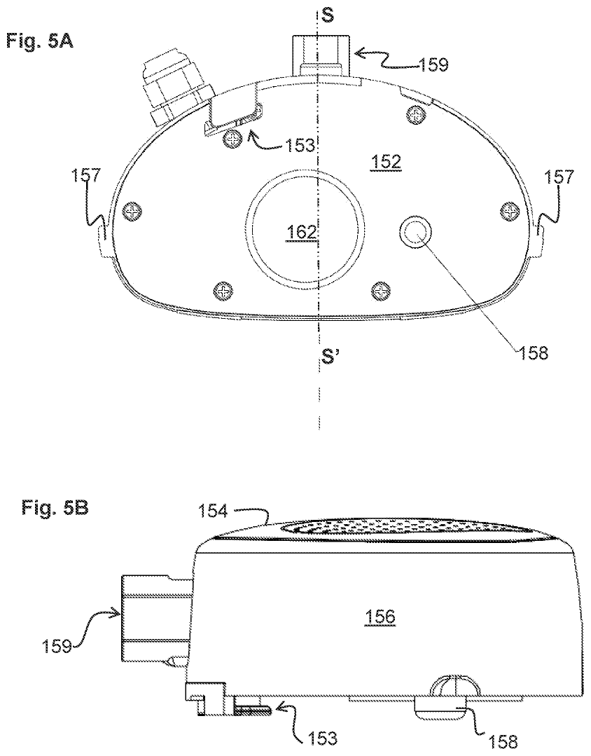

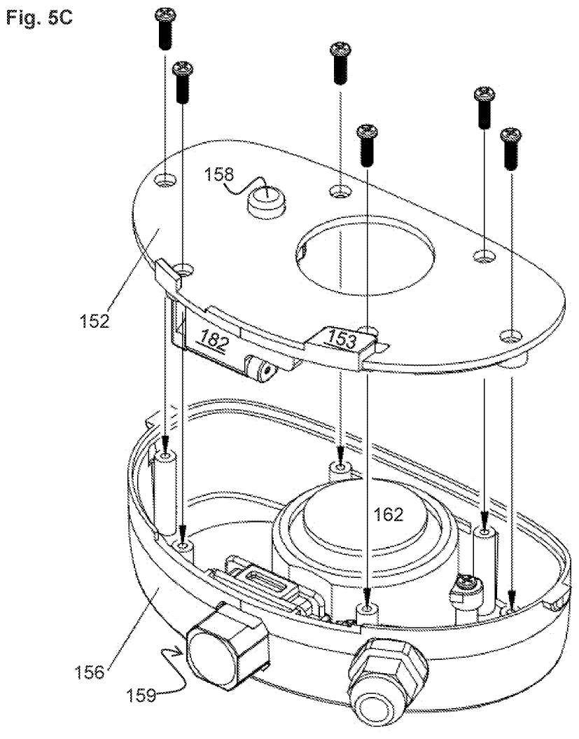

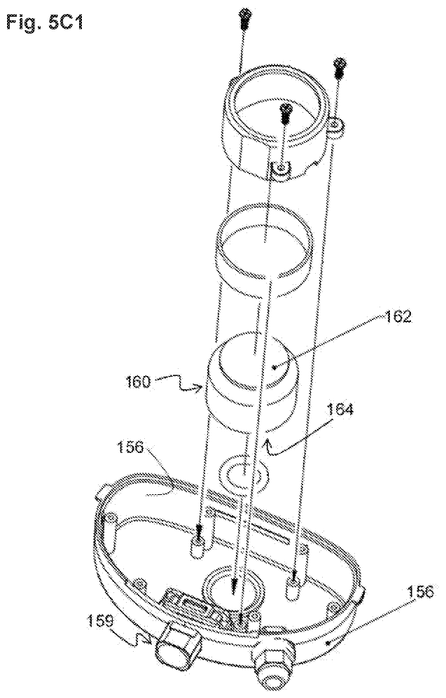

Referring to FIGS. 2A and 2B, the example audio arrangement may comprise a plurality of audio cartridges. The audio cartridges may be attached to the first peripheral wall 112 of the first container 110 and/or the second peripheral wall 122 of the second container 120. The audio cartridges may be configured to receive signals by wire connection to the signal course 128. An example audio cartridge may comprise an audio transducer and a cartridge housing. Referring to FIGS. 5A, 5B, 5C and 5C1, an example cartridge housing of the audio cartridge A1, A2, B1, B2 comprises a first surface 152 which is a front surface, a second surface 154 which is a back surface, and a peripheral wall 156 interconnecting the front surface and the back surface. The front surface, the back surface and the peripheral wall cooperate to define an internal compartment of the audio cartridge A1, A2, B1, B2.

The audio transducer 160 comprises a front surface 162 and a back surface 164. The audio transducer 160 is mounted on the cartridge housing such that the front surface is proximal the front surface of the cartridge housing and the back surface is inside the internal compartment of the audio cartridge A1, A2, B1, B2. The front surface 162 of the audio transducer is a sound propagating surface which is to mechanically vibrate to propagate audible signals. The audio transducer is configured to receive electrical audio signals from the signal source and to convert the received electrical audio signals into mechanical vibrations for onward propagation as audible signals.

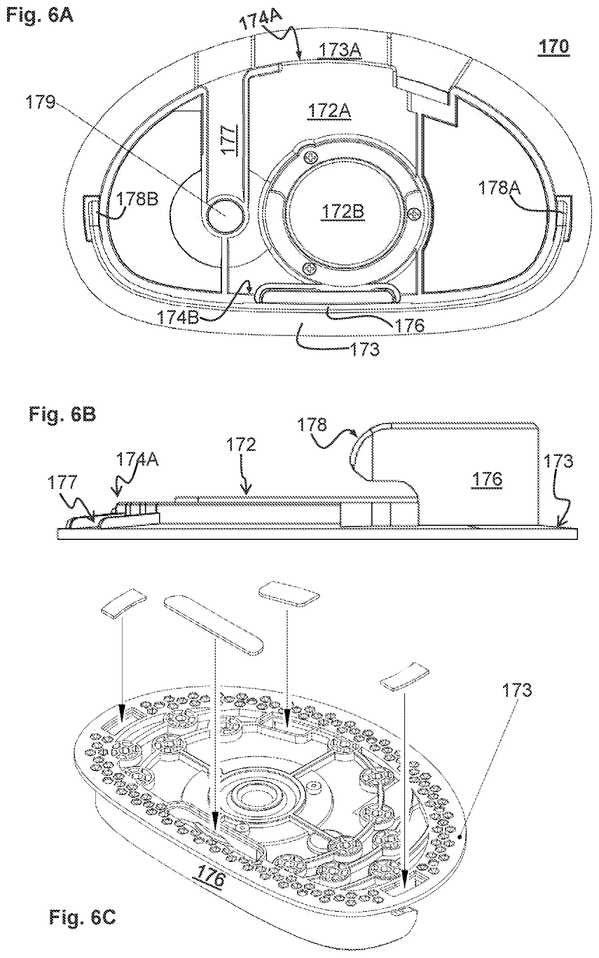

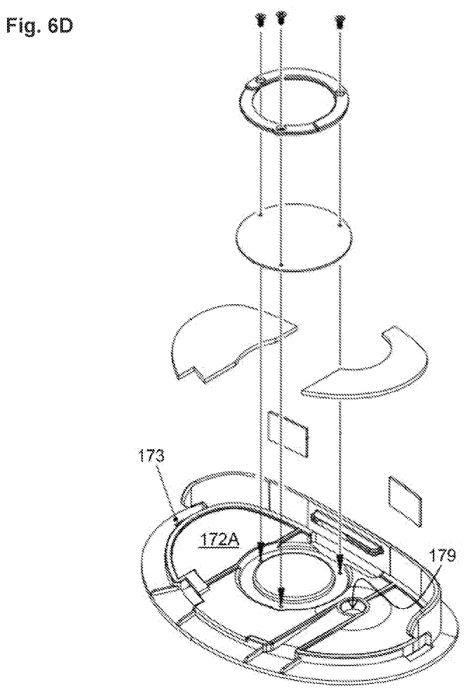

The audio cartridge A1, A2, B1, B2 is configured for attachment to the bathtub, for example, by means of a cartridge receptacle, such that mechanical vibration generated by the audio transducer can propagate through physical contact with the first container, the second container and/or the bridging portion. An example cartridge receptacle as shown in FIGS. 6A and 6B is configured as a cartridge bracket 170.

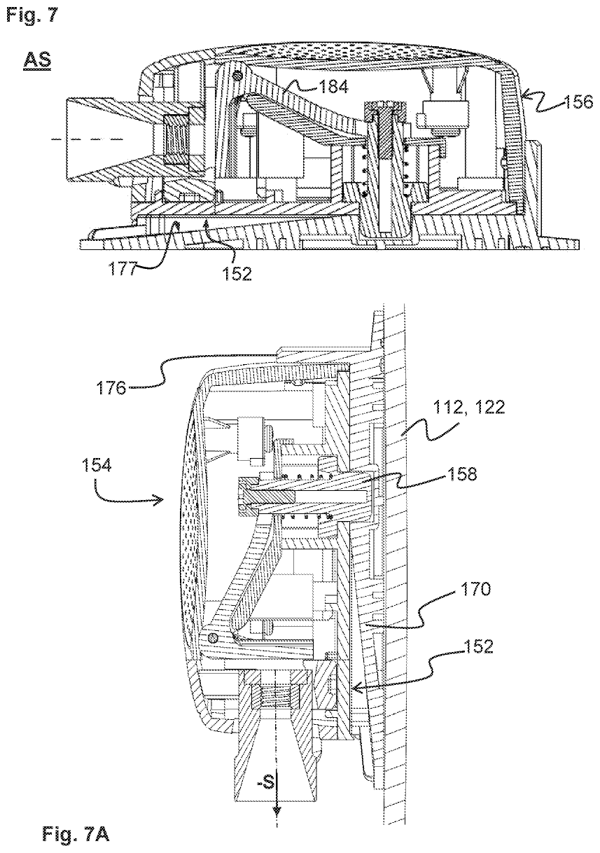

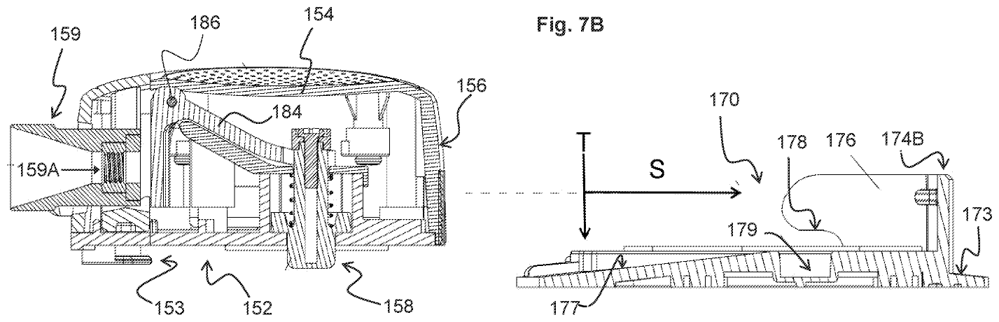

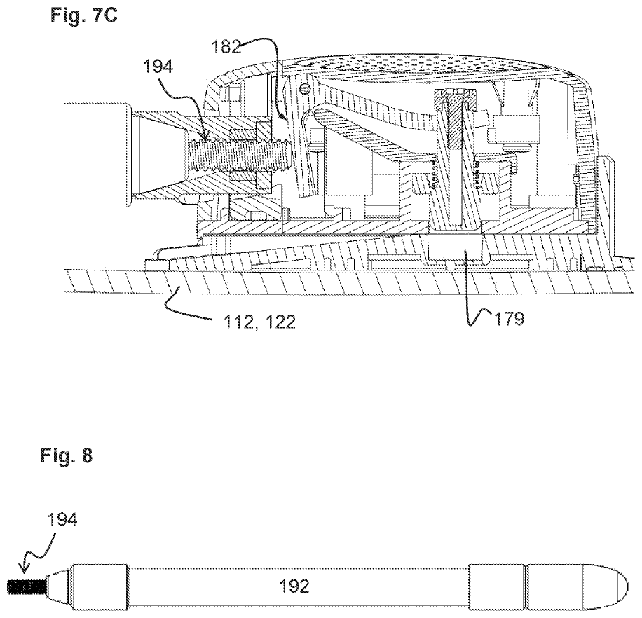

An audio cartridge assembly AS comprising an audio cartridge and a cartridge receptacle includes a cooperative retention system which is configured to facilitate retention of the audio cartridge on the cartridge receptacle, as shown in FIG. 7. The cooperative retention system comprises a retention mechanism on the audio cartridge and a counterpart retention mechanism on the cartridge receptacle. The retention mechanism on the cartridge housing may comprise an engagement means and/or a locking means. The counterpart retention mechanism on the cartridge receptacle may comprise a counterpart engagement means and/or a counterpart locking means. The engagement means and the counterpart engagement means cooperate to form an engagement system which is configured to keep the audio cartridge and the cartridge receptacle engaged, for together by pressure engagement, such as friction engagement or snap engagement. The locking means and the counterpart locking means cooperate to form a locking system which is configured to lock the audio cartridge and the cartridge receptacle together in a locked relationship when a locking position.

An audio cartridge assembly AS attached on a peripheral wall 112, 122 is shown in FIG. 7A. The audio cartridge assembly AS is configured such that the audio cartridge is detachable from the cartridge receptacle 170 by moving downwardly relative to the peripheral wall 112, 122 towards the support surface SS, that is, in a negative S direction.

The cartridge receptacle 170 may be pre-fitted or post-fitted to the peripheral wall 112, 122 of a bath-tub, for example, by gluing or other mean of fastening. A plurality of cartridge receptacles may be pre-fitted at selected locations along the inter-container space for selected attachment of audio cartridges as and when a user so desires. The cartridge receptacles are preferably configured so that an audio cartridge is to enter into snap engagement with a corresponding cartridge receptacle when moving upwards towards the cartridge receptacle.

In example embodiments, the audio cartridge A1, A2, B1, B2 and the cartridge receptacle are configured to enter into an engagement relationship of FIG. 7 by relative movement along a first direction which is an insertion direction S, as shown in FIG. 7B.

Referring to FIGS. 6A, 6B, 6C, 6D, 7, 7A and 7B, the cartridge bracket 170 comprises a base portion including a seat portion 172 and a peripheral wall extending upwardly from the base portion. The seat portion 172 comprises a forward end 174A, a rearward end 174B and lateral sides extending between the forward end 174A and the rearward end 174B. The seat portion 172 comprises an upper surface defining a seat surface and a lower surface for attaching to a support surface such as an interior surface of the bathtub. The forward end 174A, the rearward end 174B and the seat surface 172A are sequentially disposed along the insertion direction S, which is defined by an S-axis.

The peripheral wall 176 extends upwardly from the seat surface for a height H which is comparable to the height of the cartridge housing. The height of the cartridge housing is measured between the first surface and the second surface in a second direction T. The T-direction is an axial direction which is defined by a T-axis which is orthogonal to the S-axis.

The peripheral wall 176 extends to delineate the rearward end 174B of the seat portion 172 and has peripheral ends which are forward of the rearward end 174B. The peripheral ends are lateral ends which extend forwardly from the rearward portion of the peripheral wall 176 which delineate the rearward end 174B of the seat portion. The lateral ends of the peripheral wall 176 are forward free ends which are most distal or most forward from the rearward end 174B of the seat portion 172.

Each forward free end of the peripheral wall 176 is an overhanging forward portion which overhangs the base portion of the cartridge bracket 170. The overhanging forward portion cooperates with the base portion to define an elongate slot having a slot entry at its forward end. The overhanging forward portions are configured to cooperate with the base portion to form an engagement means. The engagement means may be configured as a pair of lateral clamps 178A, 178B which is to exert a clamping force in a direction parallel to the T-direction. The peripheral wall 176, comprising the peripheral ends, forms a brace which surrounds a rearward portion of the seat surface 172A.

The peripheral wall 176 has a depth which may be between ⅓ or ½ of the depth of the cartridge bracket 170. The depth of the cartridge bracket 170 is measured between the forward end of the peripheral wall 176 and the rearward end of the seat portion 172. Both the depth of the cartridge bracket 170 and the depth of the peripheral wall 176 are measured in the S-direction.

The cartridge bracket 170 comprises a web portion 173 which extends outwardly from the seat portion 172 with respect to the T-axis. The web portion includes a forward web portion 173A which is forward of the seat portion 172. The web portion has a lower surface which may be flush with the lower surface of the seat portion 172 and an upper surface which is below the seat surface at the forward end 174A. The web portion may extend to surround the seat portion 172. In some embodiments such as the present, a step is formed at the junction between the seat portion and the forward portion, and the seat surface is elevated above the forward portion by a height equal to the height of the step. The step may have a height of 1 mm or more, for example, 1 mm, 1.5 mm, 2 mm, 2.5 mm, 3 mm, 4 mm, 5 mm, etc.

Referring to FIGS. 6A to 6C, the overhanging forward portions on opposite peripheral ends of the peripheral wall cooperate with the seat surface 172A to define a pair of lateral clamps 178A, 178B. Each lateral clamp 178A, 178B comprises a slot, for example, an elongate slot, which is defined by cooperation of the overhanging forward portion and the seat surface. The elongate slot has a slot entrance at its forward end and is configured to receive a portion of the cartridge housing so that an interference engagement is formed between the lateral clamps 178A, 178B and the portions of the cartridge housing received inside the lateral clamps 178A, 178B.

The portion of the cartridge housing which is configured to be received inside lateral clamp 178A, 178B when in the engagement position may be a protruding portion 157 which projects transversely outwards from the peripheral wall 156 of the cartridge housing. The slot may be a tapering slot having a clearance in the upward direction which gradually reduces on progressing towards the rearward end. With the tapering slot, the protruding portion on the peripheral wall 156 of the cartridge housing and the overhanging portion will enter into wedged engagement on progressing into the engagement position. In some embodiments, the protruding portion may be configured as a wedging portion having a forward end which is higher than its rearward end so that the protruding portion gradually enters into wedging engagement with the lateral clamp 178A, 178B, which defines an overhanging clamp portion. In some embodiments, the wedging engagement may be formed partly by an inclined seat surface which cooperate with the overhanging clamp portion to define a tapered engagement slot.

The overhanging forward-end portions of the peripheral wall of the cartridge bracket 170 may be configured as a brace which is to exert a transversal bracing force to brace the cartridge housing. To facilitate formation of a brace, the transversal separation distance between the two overhanging lateral forward-end portions on opposite peripheral ends of the peripheral wall of the cartridge housing is smaller, for example, slightly smaller, that the width of the cartridge housing being braced. The transversal separation distance herein is measured in a transversal direction which is orthogonal to both the S-direction, which is the direction of insertion, and the T-direction, which is an upward direction with respect to the base portion. The S-direction is defined by the S-axis which may be an axis of lateral symmetry of the cartridge bracket.

Each overhanging forward-end portion of the peripheral wall has an inner surface which is parallel to the T-axis, and the inner surfaces of the two overhanging forward-end portions are oppositely facing and aligned on a transversal axis which extends in the transverse direction. The transversal axis is orthogonal to both the S-axis and the T-axis, and parallel herein includes substantially parallel, for example, with a ±15 degrees deviation. In some embodiments such as the present, the peripheral wall 176 is symmetrically disposed about the centre axes S and T.

The cartridge bracket 170 may be configured such that, when the audio cartridge is in the engagement position, the inner surfaces of the overhanging forward-end portions are in compressive engagement with the peripheral wall of the cartridge housing, and the resilience of the overhanging forward-end portions is to exert a transversely inward bracing force against the peripheral wall of the cartridge housing. The transversely inward bracing force is exerted in a transversely inward direction which is towards the S-axes.

Therefore, the peripheral wall, or more specifically the peripheral end portions of the peripheral wall, may be configured as a bracing device which is to exert a transversely inward bracing force, and/or as a clamping device which is configured to exert a clamping force in a direction parallel to the upward axis T without loss of generality. In other word, the engagement means formed by the peripheral ends of the peripheral wall may be configured as an engagement means for exerting an inward transversal engagement force and/or an upward engagement force.

The cartridge housing may include a clamping arrangement which is configured to engage with cartridge bracket 170. An example clamping arrangement comprises a clamping portion 153 which is formed underneath the first surface 152. The clamping portion 153 is formed on the rearward end of the cartridge housing and has its forward opened to form an entrance, as shown in FIG. 7B. The clamping portion 153 is configured to make clamping engagement with the seat portion when in the engagement position. To facilitate clamping engagement between the clamping portion 153 and the seat portion, a clamp receptacle is formed on a forward end portion of the seat portion underneath the seat surface. When in the engagement position, the clamp portion 153 is received inside the clamp receptacle, and the first surface 152 and the clamp portion 153 cooperate to exert a clamping force in the T-direction on the seat portion to facilitate friction engagement.

The example cartridge housing has an apertured front surface 152 which is configured to permit the sound propagation surface 162 of the audio transducer to expose. The audio cartridge and the cartridge bracket 170 are arranged such that when in the engagement relationship, the sound propagation surface 162 is in close proximity to or in abutment with the seat surface 172, whereby vibrations on the sound propagation surface 162 can be more effectively transmitted to the cartridge bracket 170 for further transmissions, for example, to the bathtub and/or the inter-container space. In some embodiments such as the present, the sound propagation surface 162 is under resilient bias in the T-direction and protrudes through the first surface 152.

The locking means and the counterpart locking means are configured to lock the cartridge and the cartridge receptacle in a locking relationship when at a locking position. The locking system comprising the locking means and the counterpart locking means is configured to lock the audio cartridge and the cartridge bracket together so that they are prevented from moving in a relative direction which is opposite to the insertion direction S when in the locking relationship. An example locking means may comprise a lock pin or a pin receptacle and a counterpart locking means may comprise, respectively, a pin receptacle and a lock pin.

The example assembly comprises a lock pin 158 on the audio cartridge and an example counterpart locking means comprises a pin receptacle 179 on the cartridge bracket 170. The pin receptacle 179 comprises a bore having a bore axis which is parallel to the T-direction and defining an indentation on the seat surface 172A. The lock pin 158 is configured to be movable in the ±T-direction between a locking position in which the lock pin 158 is inside the bore and a non-locking portion in which the lock pin 158 is outside the bore. The first surface 152 includes a pin aperture which is configured to permit through passage of the lock pin across the first surface. The lock pin 158 is under a spring urge which is configured to urge the lock pin 158 to move out of the cartridge housing and through the pin aperture on the first surface 152. When there is no obstacle on the first surface 152, the lock pin 158 will protrude out of the first surface 152 at its full extent due to the spring urge which is an axial urge in a direction opposite to the T-direction, that is, minus T-direction.

Referring to FIG. 7B, the lock pin 158 is connected to a lifting mechanism which is configured to move the lock pin 158 out of the bore. The lock pin 158 has a pin axis, a first end which is configured to pass through the first surface 152 of the cartridge housing and into or out of the bore, and a second end which is distal from the first end and connected to the lifting mechanism. The example lifting mechanism is mounted inside the cartridge housing and comprises a first arm 182, a second arm 184 and a hinge 186 which is intermediate the first arm and the second arm. The hinge has a hinge axis which is parallel to the transversal direction, that is, orthogonal to the S-direction. The hinge axis is also orthogonal to the pin axis such that forward movement of the first arm about the hinge, corresponding to clockwise movement of the first arm about the hinger axis, is to bring about upward lifting of the pin 158.

The cartridge bracket 170 includes a track which leads to the pin receptacle 179. The track extends between the forward web portion and the pin receptacle 179 and is upwardly inclined with respect to the forward web portion to form a ramp 177 which is to lead to the pin receptacle 179.

Referring to FIGS. 7A, 7B and 7C, to prepare for the audio cartridge to move into the locking relationship, a user is to align the audio cartridge with the cartridge bracket 170 in the S-axis and the T-axis. When the audio cartridge and the cartridge bracket 170 are so aligned, the centre axes of the audio cartridge and the cartridge bracket 170 are coaxial, the protruding portions which project transversely outwards from the peripheral wall 156 the cartridge housing are aligned with the entrance to the elongate slots on the cartridge bracket 170, and the clamping portion 153 aligned with the clamp receptacle underneath the seat surface.

After the audio cartridge has been so aligned with the cartridge bracket 170, the user is to move the audio cartridge in the S-direction towards the cartridge bracket 170 so that the first surface 152 of the audio cartridge is in abutment with the seat surface 172A. When the audio cartridge begins to encounter the lateral clamps 178A, 178B and the clamping portion 153 begins to encounter the seat surface 172A, the lock pin 153 would be in compressive abutment with the ramp. Further movement of the audio cartridge in the S-direction relative the cartridge bracket 170 after the lock pin 153 is in compressive abutment with the ramp will result in gradual movement of the lock pin 153 against the spring bias and into the internal compartment of the cartridge housing.

When the lock pin 153 is at the end of the ramp and the user continues to move the audio cartridge further in the S-direction, the lock pin 153 will enter into a locking position whereat the pin axis and the bore axis are aligned. When the lock pin 153 is at the locking position, the spring urge on the lock pin 153 will drive the lock pin 153 into the pin receptacle whereby the cartridge housing and the cartridge receptacle are brought into and kept in the locked relationship.

The example locking system is configured to lock the assembly in the locked relationship in which its components are prevented from detachment by relative movement in a direction opposite to the insertion direction and along the insertion plane which is defined by the S-axis.

The example retention system is configured to provide a 3-dimensional retention, including locking in a first dimension and pressure engagement in a second and third dimensions, wherein the first, the second and third dimensions are mutually orthogonal.

In the present example, the first dimension is in the negative S-direction, and the second dimension and the third dimension are, respectively, the transversal inward direction and the negative T direction, that is, towards the seat surface. The 3-dimensional retention may comprise 2-dimensional locking plus 1-dimensional engagement or 1-dimensional locking plus 2-dimensional engagement. The locking may be configured in the first dimension and/or the second dimension without loss of generality.

The example retention system may be configured to provide a 2-dimensional retention, for example, 2-dimensional engagement only or 1-dimensional locking plus 1-dimensional engagement without loss of generality.

The cartridge may include a release mechanism to facilitate release of the cartridge from the locking relationship and subsequent removal.

Referring to FIG. 7A, the second end of the pin 158 is connected to the non-hinged end of the second arm of the lifting mechanism. When the first arm is moved against the spring urge on the pin 158, the second arm of the lifting mechanism will follow the movement of the first arm about the hinge, thereby lifting the second end of the pin upwards and towards the second surface 154 of the cartridge housing.

When the first end of the pin 158 is lifted clear of the pin receptacle or the seat surface 172A, a user can remove the cartridge from the cartridge bracket 170 by moving the cartridge in the negative S-direction relative to the cartridge bracket 170. Therefore, the lifting mechanism is configured as a release mechanism.

After the cartridge has been released from the retention relationship, a user can then move the cartridge out of the snap engagement relationship, for example, by moving the cartridge in the negative S-direction. After the cartridge has been moved out of the snap engagement relationship, a user can then move the cartridge to fully separate the cartridge from the cartridge bracket 170.

The cartridge housing may be moved into or out of the engagement position by hand or by tool. When the cartridge bracket 170 is mounted in a location which is not accessible or easily accessible by hand, for example, a location which is accessible only through a narrow passage longer than the arm length of a user, a tool to facilitate attachment and/or removal would be helpful.

A tool for moving the cartridge housing into or out of the engagement position may comprise a head portion which is configured for making mechanical coupling with the cartridge housing and a handle portion which is an elongate portion configured to act as an extension to extend the arm reach of a user.

The example cartridge housing includes a tool coupling port 159 which is configured to make mechanical coupling with a tool whereby the cartridge can be moved following movement of the tool, and an access port 159A which is an aperture formed on the peripheral wall 156, the access port 159A being axially aligned and in abutment with the tool coupling port 159.

An example tool comprises a head portion 194 which is configured to make mechanical coupling with the tool coupling port and a handle portion 192 which is an elongate portion configured as an extension to extend the arm reach of a user, as shown in FIG. 8.

The example tool coupling port 159 comprises a threaded tubular portion which is configured to engage with a correspondingly threaded head portion of the tool.

When the threaded head portion of the tool and the threaded coupling port on the cartridge housing are in threaded engagement, a user can hold the cartridge housing and move it to a location which is beyond reach of its arm, for example, into a distal engagement position where the cartridge bracket is located. The mechanical coupling can be by means of bayonet coupling or other extension coupling without loss of generality.

In order to move the cartridge housing into engagement with the cartridge bracket, a user is to align the engagement means on the cartridge housing with the counterpart engagement means on the cartridge bracket. After the engagement means and the counterpart engagement means have been aligned, a user is to move the cartridge housing towards the cartridge bracket. When the engagement means and the counterpart engagement means begin to enter into engagement, the locking means is on its way towards the locking position, and will automatically enter into the locking relationship by the spring urge.

The access port 159A is configured to permit access to the release mechanism from outside of the cartridge housing. The example access port is formed on the rearward end of the peripheral wall of the cartridge housing and aligned with the tool coupling port 159 and its centre axis, which is parallel to or coaxial with the S-axis.

The tool may comprise a forward-end portion which is configured to pass through the access port and interact with the release mechanism. The tool may be configured so that the forward-end portion has a length such that when the tool and the cartridge are in full mechanical coupling, the forward end portion is to act on the release mechanism such that the locking means is moved out of the locking relationship. When the locking means is moved out of the locking relationship, the cartridge can be moved out of the engagement position and separated from the cartridge receptacle. Therefore, the tool can be used to uninstall the cartridge from the cartridge receptacle.

A tool configured with such a forward-end portion may be used to install the cartridge on the cartridge receptacle. When the tool and the cartridge are in full mechanical coupling, a user can move the cartridge into the engagement relationship while the locking means is in a non-locking state. After the cartridge has been brought into the engagement relationship, removal of the tool from the cartridge housing will release the locking means from the non-locking state and the spring urge on the locking means will then urge the locking means into the locking state.

A user may use the tool to remove the audio cartridge from the cartridge receptacle. To remove the audio cartridge, a user will first align the head portion of the tool with the tool coupling port 159 and then to move the head portion of the tool forwardly towards the release mechanism after the head portion has been mechanically coupled with the tool coupling port. When the head portion of the tool has advanced for a sufficient axial distance in the S-direction, the head portion will act on the locking mechanism to cause unlocking of the locking mechanism. After the locking mechanism has been unlocked, a user will move the cartridge housing out of engagement with the cartridge receptacle and finally separate the cartridge from the cartridge receptacle.

Where the head portion is threaded, the locking and unlocking of the locking mechanism will progress gradually as the tool progresses or retreats gradually by threaded movements.

The tool may have a first head portion on a first end of the handle portion and a second head portion on a second end of the handle portion. The first head portion may have a first length which is configured such that when the tool and the cartridge are mechanically coupled, the length of the first head portion is sufficient to activate the release mechanism such that locking between the cartridge and the cartridge receptacle is released. The second head portion may have a second length which is configured such that when the tool and the cartridge are mechanically coupled, the length of the second head portion is not sufficient to move or activate the release mechanism and the locking mechanism will automatically enter into the locking relationship on reaching the locking position.

The electro-acoustic signal source, or signal source in short, is mounted inside a cartridge housing to form a signal cartridge. The signal source comprises a sign receiver, a signal amplifier, and a power input. The signal receiver may be a wireless receiver, for example, a wireless receiver configured to receive Bluetooth or wireless signals of other protocols. The signal cartridge is configured for low voltage operations and the power input is configured to receive a low-voltage (LV) power supply, for example a 14.8V DC power supply for user safety.

An audio transducer on the first peripheral wall may have its sound propagation surface mounted facing towards the interior of the first container. An audio transducer on the second peripheral wall may have its sound propagation surface mounted facing away from the first container.

While the cartridge housing is configured for receiving an audio transducer, the configurations of the cartridge housing, the cartridge bracket, and the tool can be used in apparatuses or situations where installation at or removal from a difficult-to-access location without loss of generality.

While the example audio arrangement is attached to the body of the bathtub, persons skilled in the art would of course understand that the audio arrangement can be detached from the bathtub, for example, places in the inter-container space without in abutment with the bathtub without loss of generality.

The example audio cartridges are configured to receive electroacoustic signals by wire connection to the signal course, it would be understood by persons skilled in the art that the electroacoustic signals can be wireless transmitted, for example, by Bluetooth® or other wireless transmission protocols without loss of generality.

The example signal source is configured to be wireless controlled, for example, using Bluetooth® transmission protocols. It would be understood by persons skilled in the art that the signal source can be controlled by wired connection or by wireless protocols of any suitable set up without loss of generality.

1. A bathtub comprising a first container which is an inner container, a second container which is an outer container, and a set of audio transducers comprising at least one audio transducer;
wherein the first container comprises a first peripheral wall and a base portion having a base surface, the first peripheral wall surrounding and cooperating with the base surface to define a liquid-receiving volume of the first container, and wherein the liquid receiving volume has a depth which is measured along an axial direction;
wherein the second container comprises a second peripheral wall which surrounds the first peripheral wall, the second peripheral wall cooperating with the first peripheral wall to define a peripheral airgap which is an interwall airspace surrounding the first peripheral wall;
wherein the first peripheral wall and the second peripheral wall are interconnected by a peripherally extending bridging portion, and wherein the bridging portion defines a top end of the peripheral airgap; and
wherein the set of audio transducers is received inside the peripheral airgap and is configured for generating audio vibrations inside the interwall airspace for transmitting out of the first container through the first peripheral wall and out of the second container through the second peripheral wall.

2. The bathtub according to claim 1, wherein the first container is elevated above a support surface by a support structure, and wherein an airgap which is a bottom airgap in communication with the peripheral airgap is present between the first container and the support surface.

3. The bathtub according to claim 2, wherein the peripheral airgap and the bottom airgap cooperate to form an internal airspace of a sound box of a speaker, the speaker being cooperatively defined by the first container, the second container and the bridging portion; and/or wherein the first container, the second container, and the bridging portion cooperate with the support surface to form a sound box of a speaker.

4. The bathtub according to claim 1, wherein the first container is an acrylic container or bathtub.

5. The bathtub according to claim 1, wherein the second container overhangs the first container and is suspended from the first container by the peripherally extending bridging portion.

6. The bathtub according to claim 1, wherein the first peripheral wall and the second peripheral wall are spaced apart and are separated by a transverse separation distance, and wherein the separation distance is between 2 cm and 25 cm, including between 10 cm and 20 cm.

7. The bathtub according to claim 1, wherein the first peripheral wall and the second peripheral wall are configured to vibrate at audio frequencies during operation of the set of audio transducers.

8. The bathtub according to claim 1, wherein the audio transducer comprises a forward-facing surface which is an audio signal propagation surface, and wherein the audio signal propagation surface is in abutment with the first peripheral wall or the second peripheral wall.

9. The bathtub according to claim 1, wherein the set of audio transducers comprises a plurality of audio transducers, and wherein at least one audio transducer is attached to the first peripheral wall and at least one audio transducer is attached to the second peripheral wall.

10. The bathtub according to claim 1, wherein the second peripheral wall comprises a first surface which is an inner surface oriented to oppositely face the first container and a second surface which is an outer surface oriented to face away from the first container; and wherein audio signal propagation surface of the audio transducer is attached to the inner surface of the second peripheral wall.

11. The bathtub according to claim 10, wherein the audio transducer comprises a forward-facing surface which is an audio signal propagation surface and a rearward-facing surface which is oriented to face the first peripheral wall, and wherein the forward-facing surface is in abutment with the first surface and is intermediate the rearward-facing and the second peripheral wall.

12. The bathtub according to claim 1, wherein the bridging portion extends transversely outwards from a top edge of the first peripheral wall, and wherein the second peripheral wall extends downwardly from an outer edge of the bridging portion to intermediate the base portion of the first container and the support surface.

13. The bathtub according to claim 1, wherein the first container extends along a longitudinal axis which defines a longitudinal direction and length of the first container, extends along an axial direction which is orthogonal to the longitudinal direction and defines depth of the first container, and extends along a transversal direction which is orthogonal to both the longitudinal direction and the axial direction to depth width of the first container, and wherein the length, the width and the depth are configured to receive an adult body of an average size for bathing.

14. The bathtub according to claim 1, wherein the peripheral airgap is configured as a peripheral air channel for sound to travel along a closed loop around the first container and the second container.

15. The bathtub according to claim 1, wherein the second container is an acrylic with reinforcement of fiber glass and resin container.

16. The bathtub according to claim 1, wherein the first container is configured as a bathtub having a bathtub volume.

17. The bathtub according to claim 1, wherein the first peripheral wall is configured as a first audio signal transmission surface surrounding the volume of the first container; and wherein the second peripheral wall is configured as a second audio signal transmission surface for transmitting audio vibrations away from the first container.

18. The bathtub according to claim 1, further comprising an electro-acoustic signal source, wherein the signal source is configured to deliver electro-acoustic signals to the set of transducers, and wherein the signal source is received inside the internal airspace of a speaker box and/or is wall mounted inside the second container.

19. The bathtub according to claim 18, wherein the signal source is powered by a portable power source.

20. The bathtub according to claim 18, wherein the signal source is powered by a low voltage DC power source.
